(19) United States
(12) Patent Application Publication
(10) Pub. No.: US 2018/0297870 A1
(43) Pub. Date: Oct. 18, 2018

(54) PORTABLE WATER FILTER DEVICE

(71) Applicants: Matías Osuna Estrada, Medellin (CO); Tomas White Restrepo, Medellin (CO); Samuel Ceballos Posada, Medellin (CO); Sara Cohen Mejía, Medellin (CO); Felipe Londoño Benjumea, Medellin (CO); Pedro Juan Celedón Vélez, Medellin (CO); Gregorio Pérez Bernal, Medellin (CO); Sofía Cárdenas Soto, Medellin (CO); Valentina Echavarría Vásquez, Medellin (CO)

(72) Inventors: Matías Osuna Estrada, Medellin (CO); Tomas White Restrepo, Medellin (CO); Samuel Ceballos Posada, Medellin (CO); Sara Cohen Mejía, Medellin (CO); Felipe Londoño Benjumea, Medellin (CO); Pedro Juan Celedón Vélez, Medellin (CO); Gregorio Pérez Bernal, Medellin (CO); Sofía Cárdenas Soto, Medellin (CO); Valentina Echavarría Vásquez, Medellin (CO)

(21) Appl. No.: 15/954,492

(22) Filed: Apr. 16, 2018

Related U.S. Application Data
(60) Provisional application No. 62/485,532, filed on Apr. 14, 2017.

(51) Int. Cl. C02F 1/50; C02F 1/00

(52) U.S. Cl. CPC C02F 1/50; C02F 2307/02; C02F 2303/04; C02F 1/002

(57) ABSTRACT

A portable water filtering container having a solid-particle removing filter inside the container and sodium hypochlorite to destroy bacteria in non-potable water is provided.

### CLAIM OF PRIORITY

This application is a non-provisional application of U.S. Provisional Application No. 62/485,532, filed Apr. 14, 2017, which is hereby incorporated by reference in its entirety.

### FIELD OF THE INVENTION

The present invention relates generally to a device that filters water and that is portable such that it may be used as a personal, portable water filter.

### BACKGROUND OF THE INVENTION

Water is a natural resource that is of strategic importance for tourism activities and survival, especially when its availability in a drinkable form is not guaranteed. Clean water supply is paramount for the mental and physical performance and success of outdoor endeavors.

Various portable devices are available for purifying water. Many are designed to support individuals embarking on international travel, adventure challenges, and expeditions where the quality of the water supply is in question. Many are used by expedition companies, explorers, adventurers and preppers for producing clean water in areas where clean, potable water cannot be guaranteed.

For example, a product known as the LifeSaver Bottle has an interchangeable filter that filters bacteria and viruses, larger than 15 nanometers. The product claims to have a filter capable of delivering up to 6,000 liters of clean water for individual use. The LifeSaver Bottle holds up to 750 ml at any one time. However, the bottle and filter are very expensive and, thus, not affordable by the general public.

The Life Straw Go is another product that acts as a personal water filter and bottle. It claims to be a refillable water bottle with filter that can convert contaminated water into drinking water by filtering protozoa and bacteria. It is more reasonably priced than the LifeSaver Bottle.

### SUMMARY OF THE INVENTION

The present invention relates generally to a portable device that filters water. In particular, the device is portable and lightweight and allows filtration of water to make it potable for human consumption.

The invention is based on the concept of filtering water and then treating it with a dose of sodium hypochlorite, which may be embedded in the filter structure or added separately. After approximately 30 minutes (at an appropriate concentration of sodium hypochlorite, such as about 5.25/cm³, which is about one drop per 2.5 liters), most or all of the bacteria in the water will be killed.

The device employs a series of plastic and cloth filters as a multilayer system arranged to filter dirt from the contaminated water. Such layers may contain an appropriate dose of sodium hypochlorite that will act to purify the water while it is being filtered of solid particles.

The device may be constructed as a container to hold the filter and a ring inside to keep the filter in place while the water is being filtered.

### BRIEF DESCRIPTION OF THE DRAWINGS

The present invention now will be described more fully hereinafter with reference to the accompanying drawings, in which some, but not all embodiments of the invention are shown. The present invention may be embodied in many different forms and should not be construed as limited to the embodiments set forth herein; rather, these embodiments are provided so that this disclosure will satisfy applicable legal requirements and demonstrate exemplary embodiments of the invention. Repeat use of reference characters in the present specification and drawings is intended to represent same or analogous features or elements of the invention. A full and enabling disclosure of the present invention, including the best mode thereof directed to one of ordinary skill in the art, is set forth in the specification, which makes reference to the appended drawings, in which:

FIG. 1 is a schematic representation of one embodiment of the present invention;

FIG. 2 is a schematic representation of another embodiment of the present invention;

FIG. 3 is a schematic representation of another embodiment of the present invention;

FIG. 4 is a schematic representation of an embodiment of the filter portions of the present invention;

FIG. 5 is a schematic representation of an embodiment of the present invention in use;

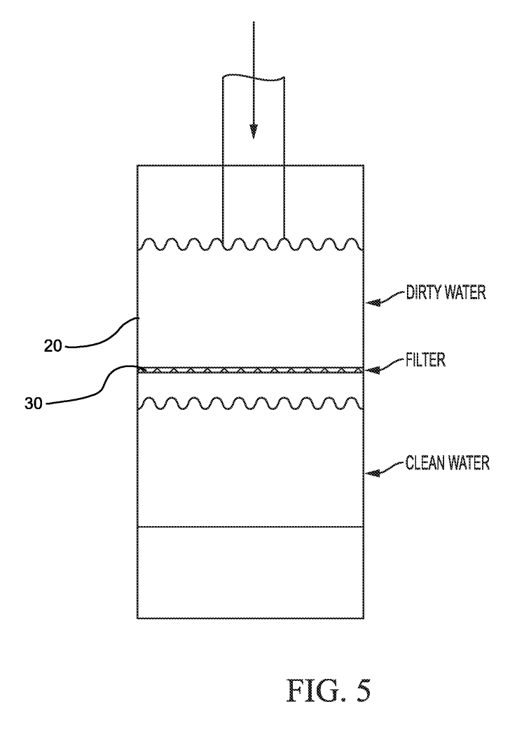

FIG. 6 is a schematic representation of another embodiment of the present invention;

FIG. 7 is a schematic top view representation of an embodiment of a ring that can be used in the embodiment shown in FIG. 6;

FIG. 8 is a schematic side view representation of an embodiment of a ring that can be used in the embodiment shown in FIG. 6;

FIG. 9 is a side view, cut-away schematic representation of the ring of FIGS. 7 and 8 shown in place in filter of an embodiment of the present invention of FIG. 6;

FIG. 10 is a schematic representation of another embodiment of the filter portions of the present invention;

FIG. 11 is a schematic representation of the filter portion of FIG. 10 shown in another embodiment of the present invention;

FIG. 12 is a schematic representation of an embodiment have the filter portion of FIG. 10;

FIG. 13 is a side view of one particular filter arrangement according to an embodiment of the present invention;

FIG. 14 is a perspective view showing contaminated water being filtered through an embodiment of the present invention;

FIG. 15 is a perspective view of contaminated water on the left prior to filtering and of filtered/decontaminated water on the right after processing with the present invention; and

FIG. 16 is a top view of various parts of the device in break-away, with one filter being 1.0, the container being 2.0, another filter being 3.0, and the holding device (ring) being 4.0.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The present invention can be best understood by reference to the drawings, all of which show various embodiments of the presently inventive portable water filter device.

The Figures illustrate various embodiments of the present invention, including various filter arrangements and various containers that can be employed. One of ordinary skill in the art would understand the function, structure, and use of such arrangements based on the Figures and the present disclosure.

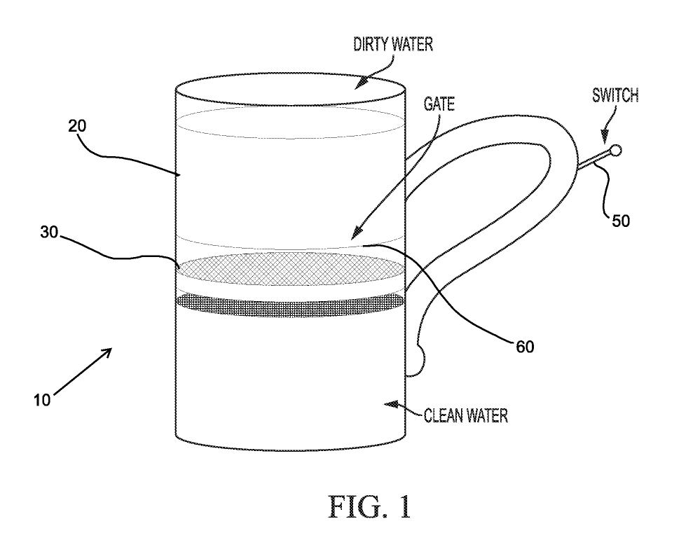

In particular, as shown for example in FIG. 1 and other figures, the present invention is a portable device 10 that filters water. Parts of the portable filtering device 10 include a container 20, a filter 30 (that may be loaded with a cleansing material such as sodium hypochlorite), and a particular structure to hold the filter 30 in place in the refillable, filtering bottle or other portable filtering device 10. Optionally, the device may include a switch 50 for controlling a gate 60 to allow for opening and closing of the filter 30. The device is portable and lightweight and allows filtration of water to make it potable for human consumption.

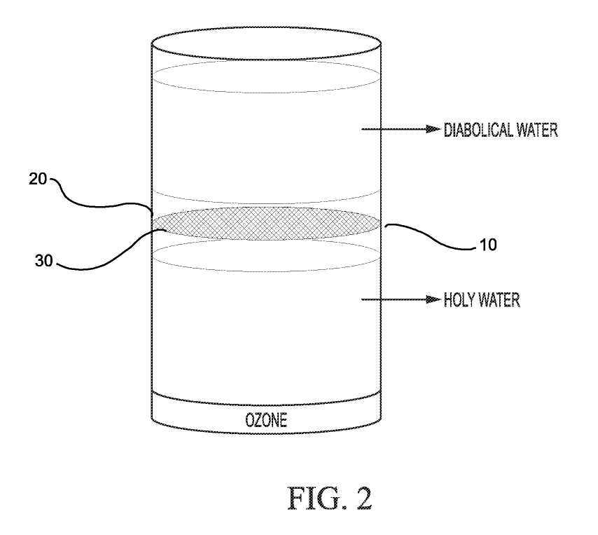

FIG. 2 shows dirty, or “diabolical” water, filter 30, and then the cleaned or “holy” water in a portable filtering device. Ozone may be present in the bottom of the container for additional purification.

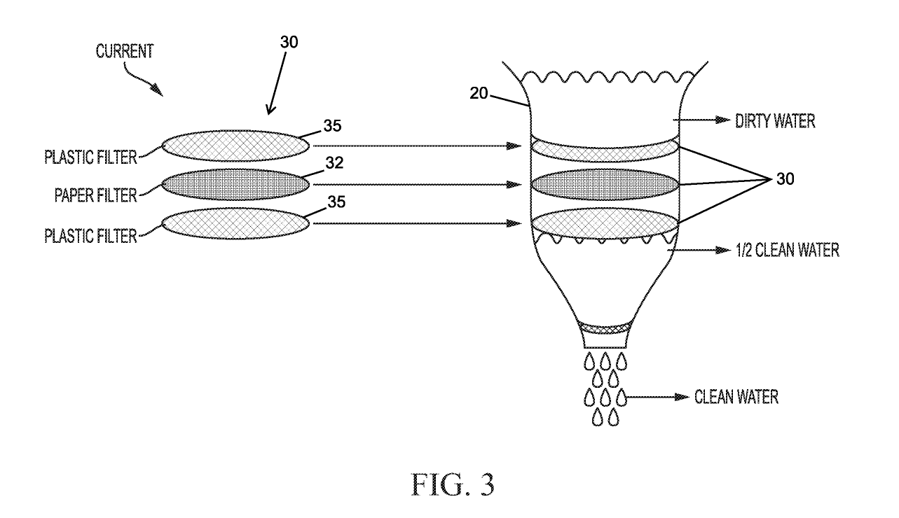

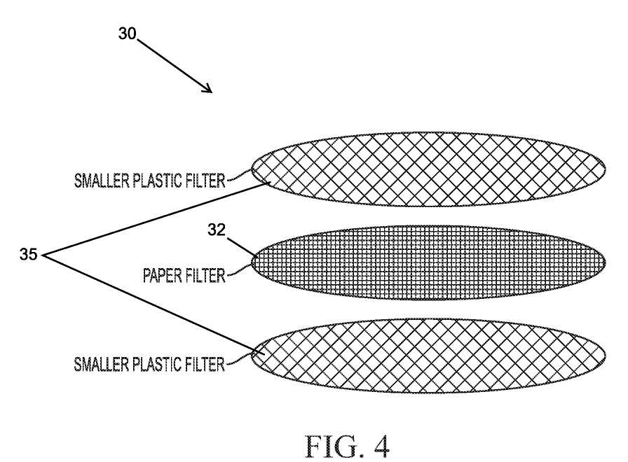

FIGS. 3 and 4 show one particular filter 30 design wherein three separate filters are used: a paper filter 32 sandwiched between two plastic filters 35.

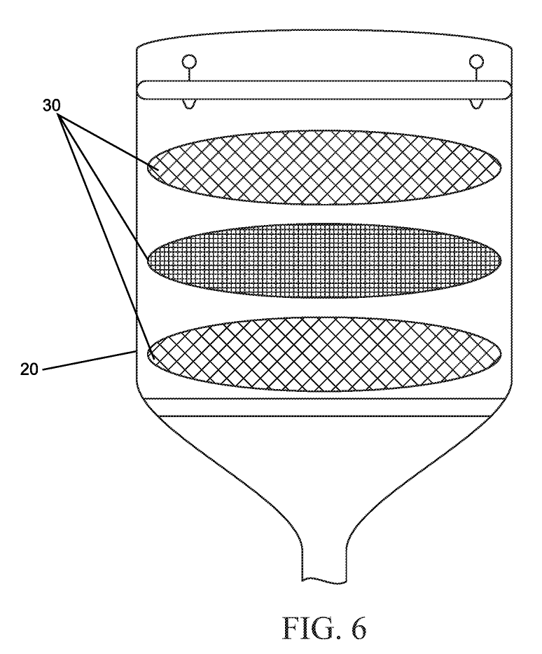

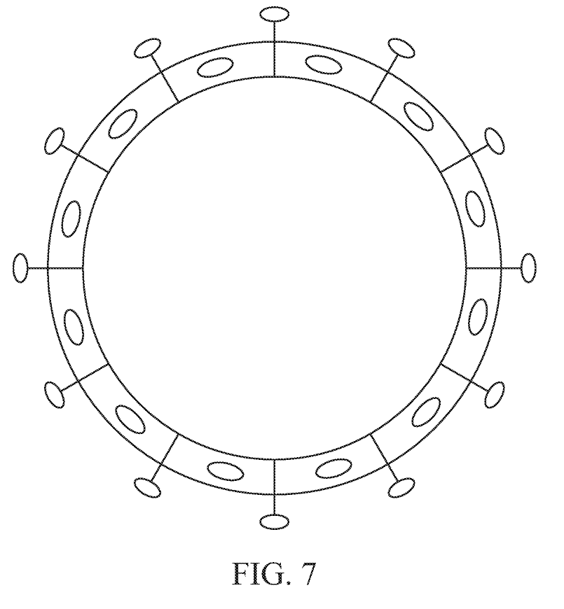

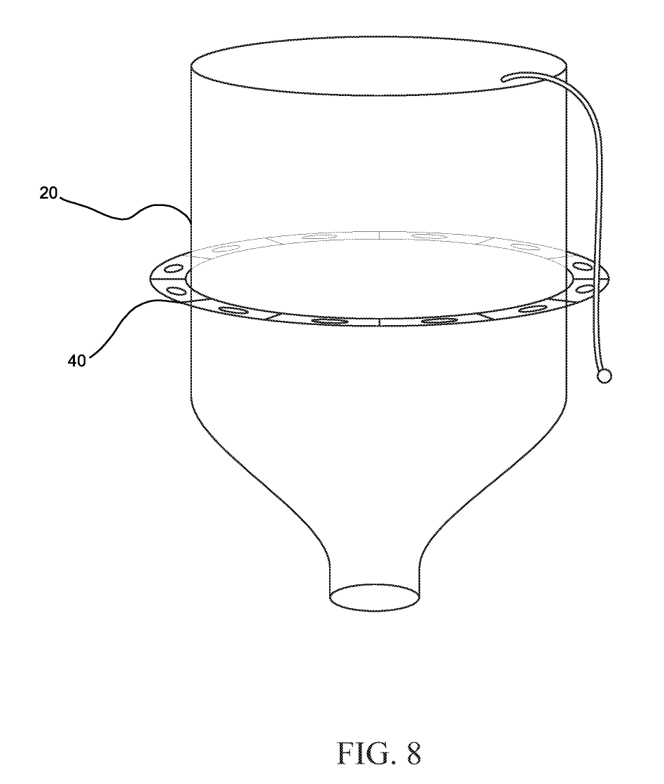

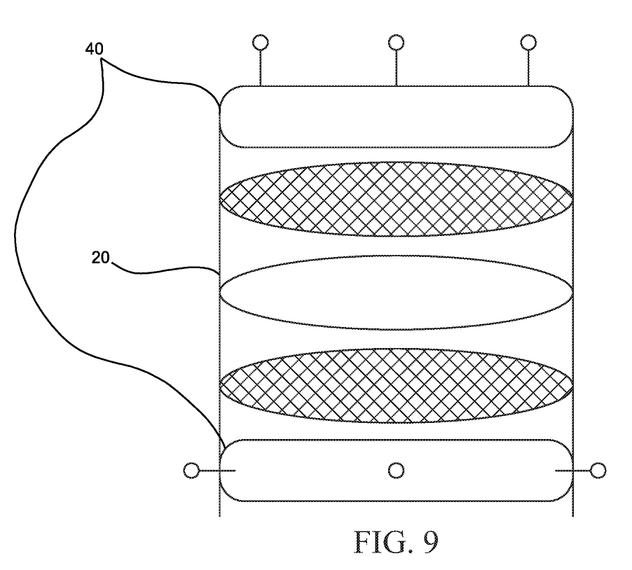

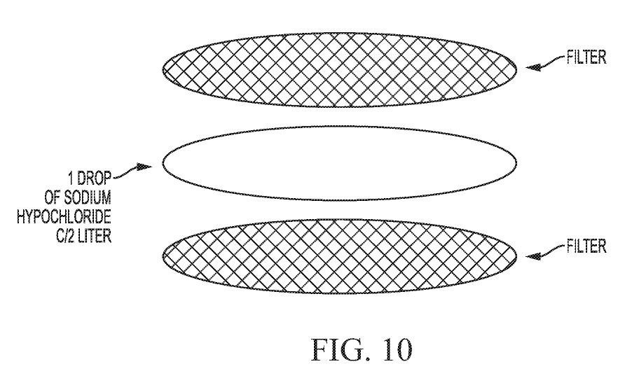

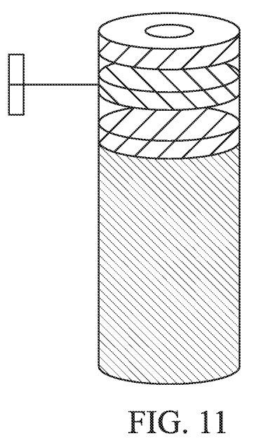

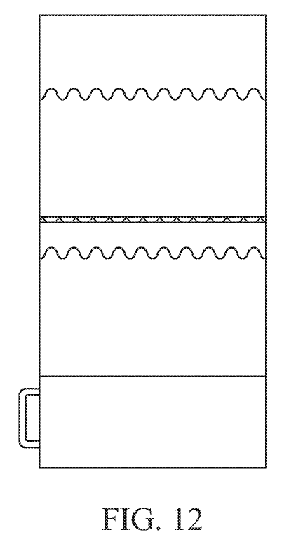

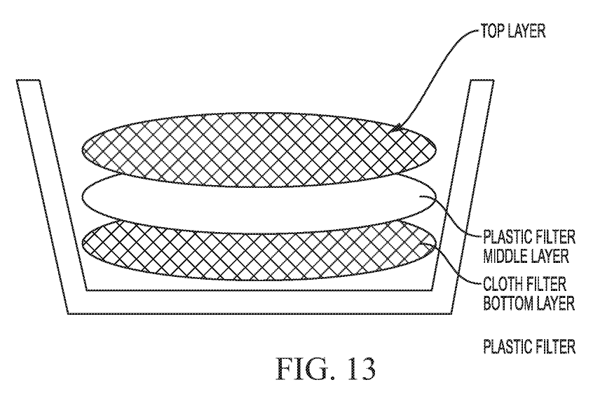

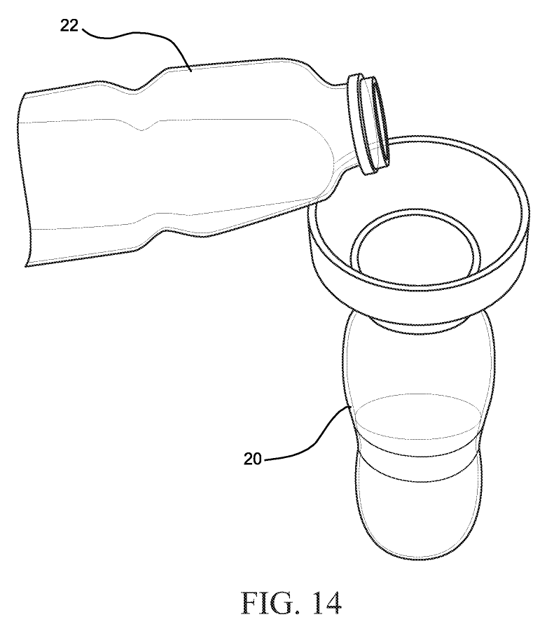

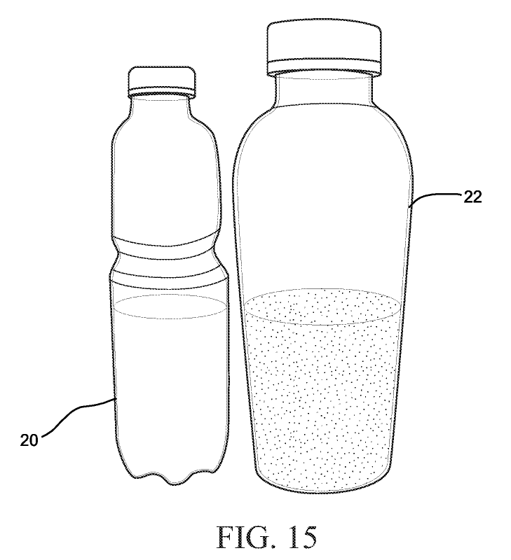

FIGS. 6-13 illustrate various other filter designs as well as mechanisms for holding the filters in place, such as with ring 40 (illustrated in FIGS. 8 and 9). FIG. 14 illustrates the filtering method of the present portable filtering device 20 and FIG. 15 illustrates filtered water in container 20 and contaminated, unfiltered water in container 22.

The invention is a portable water filtering container having a solid-particle removing filter inside the container and sodium hypochlorite to destroy bacteria in non-potable water. The invention is based on the concept of filtering water and then treating it with a dose of sodium hypochlorite, which may be embedded in the filter structure or added separately. After approximately 30 minutes (at an appropriate concentration of sodium hypochlorite, such as about 5.25/cm³, which is about one drop per 2.5 liters), most or all of the bacteria in the water will be killed.

The device employs a series of plastic and cloth filters as a multilayer system arranged to filter dirt from the contaminated water. Such layers may contain an appropriate dose of sodium hypochlorite that will act to purify the water while it is being filtered of solid particles.

The purpose of the filter is to remove suspended thick solids and particulates. Thus, the filter can be of any porosity desired. The filtering system may be layered to go from bigger pores to smaller pores in a graduated flow-through system.

The purpose of the sodium hypochlorite is to remove microorganisms and to further remove them as ozone, chlorine, and/or hydrogen peroxide. The amount of chlorine created by the sodium hypochlorite addition may be from 0.2 to about 1.2 ppm chlorine, with an average of approximately 0.5 ppm.

The device may be constructed as a container 20 to hold the filter and a ring 40 (as shown in FIGS. 8 and 9) may be included to keep the filter in place while the water is being filtered.

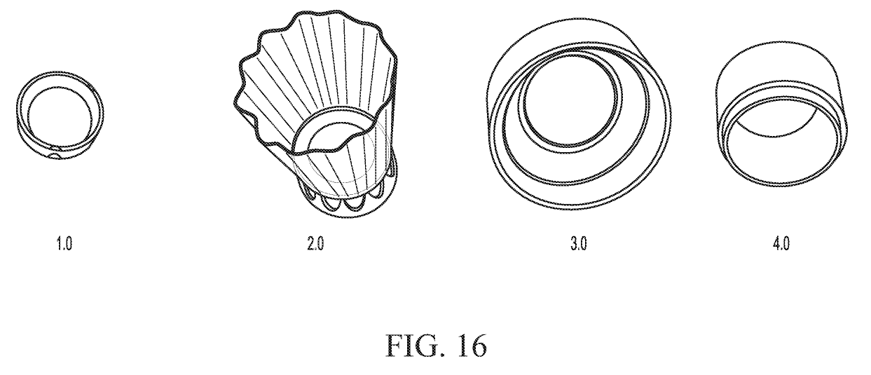

FIG. 16 illustrates various parts of the filtering device in break-away, with one filter being 1.0, the container being 2.0, another filter being 3.0, and the holding device (ring) being 4.0.

These and other modifications and variations to the present invention may be practiced by those of ordinary skill in the art without departing from the spirit and scope of the present invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

The invention claimed is:

1. A portable water filtering bottle comprising:
a. a container;
b. a filter within the container that comprises at least two layers of filtering material to filter solid particles from water being filtered by the filter;
c. sodium hypochlorite within the container for decontaminating bacteria from water to be filtered.

2. The portable water filtering bottle of claim 1 wherein the sodium hypochlorite is embedded in one or more of the layers of filtering material.

3. The portable water filtering bottle of claim 1 wherein the sodium hypochlorite is loosely contained in the container and is not embedded in any of the layers of filtering material.

4. The portable water filtering bottle of claim 1 wherein the filter is held in place in the container by a ring adapted for holding the filter in place.

5. A method of filtering contaminated water to make the water potable, the method comprising:
a. providing a portable water filtering bottle comprising a container, a filter within the container that comprises at least two layers of filtering material to filter solid particles from water being filtered by the filter, and sodium hypochlorite within the container for decontaminating bacteria from water to be filtered;
b. providing water to the container by pouring the water through the filter so as to remove certain solid particles from the water; and
c. providing sodium hypochlorite to the water that is being filtered.

6. The method of claim 5 wherein the sodium hypochlorite is embedded in one or more layers of the filtering material.
